(19) United States
(12) Patent Application Publication
(10) Pub. No.: US 2026/0105417 A1
(43) Pub. Date: Apr. 16, 2026

(54) BACKEND EMAIL SYSTEMS AND METHODS FOR PROVIDING CUSTOMIZABLE MAILBOX LAYOUTS

(71) Applicant: Notion Labs, Inc., San Francisco, CA (US)

(72) Inventors: Arpeet Kale, San Jose, CA (US); Peter Lu, San Francisco, CA (US); Byeong Chan Lee, Long Island City, NY (US); Andrew Milich, San Francisco, CA (US); Ryan Kuang, Pasadena, CA (US); Nishil Shah, San Francisco, CA (US)

(21) Appl. No.: 19/244,336

(22) Filed: Jun. 20, 2025

Related U.S. Application Data
(60) Provisional application No. 63/708,193, filed on Oct. 16, 2024.
(60) Provisional application No. 63/779,072, filed on Mar. 27, 2025.

(51) Int. Cl. G06Q 10/107; H04L 51/212; H04L 51/42

(52) U.S. Cl. CPC G06Q 10/107; H04L 51/212; H04L 51/42

(57) ABSTRACT

An electronic device receives a first input on a mailbox user interface to select an interface element indicating a particular layout among multiple layouts. These layouts represent different ways of arranging email messages and are each associated with an identifier. Each layout defines a set of columns, with each column representing values derived from email message properties. The layouts are stored on a backend server system. In response to the first input, the device retrieves the particular layout from the backend server system based on its identifier. The mailbox user interface then displays multiple email messages arranged in the selected layout, including a table with multiple rows and a specific set of columns defined by the layout. Each row corresponds to an email message, with values for the columns derived from the properties of the email messages.

### CROSS-REFERENCE TO RELATED APPLICATIONS

This application claims priority to and the benefit of U.S. Provisional Patent Application Ser. No. 63/779,072, filed Mar. 27, 2025, and claims priority to and the benefit of U.S. Provisional Patent Application Ser. No. 63/708,193, filed Oct. 16, 2024, which are incorporated by reference herein in their entirety.

### BACKGROUND

Email mailboxes are digital storage spaces where incoming and outgoing email messages (also referred to as emails) are stored and managed. They allow users to organize, read, and respond to email messages efficiently, often featuring folders, labels, and search functionalities to streamline communication. Generally, email messages are presented in an inbox organized in a list format, where each email message is presented as a separate row. Typically, the list includes columns for the sender's name, subject line, date received, and sometimes a snippet of the email message's content (e.g., a beginning of an email message). Email messages are usually sorted by date, with the most recent messages appearing at the top. Unread messages are often highlighted or bolded to distinguish them from read messages.

Conventional mailbox layouts can become overwhelming and cluttered, especially for users with high message volumes. Cluttered mailbox layouts can be challenging for users because they can make it difficult to quickly find and prioritize important email messages, leading to potential missed communications and decreased productivity. The overwhelming amount of information in a disorganized layout can cause cognitive overload, making it harder for users to focus and efficiently manage their email messages.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace, which may be used in examples of the present disclosure.

FIG. 4 is a block diagram illustrating an email system, in accordance with some embodiments.

FIGS. 5A through 5F illustrate an email user interface, in accordance with some embodiments.

FIG. 6 is a flow diagram illustrating a process for providing customizable mailbox layouts in an email system, in accordance with some embodiments.

FIG. 7 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for backend email systems and methods for providing customizable, extensible layouts for mailboxes. Conventional email systems use fixed layouts and predefined attributes for mailbox management. Such limitations can restrict the flexibility needed to cater to diverse user requirements. Current mailbox layouts lack a robust and extensible data model that can support customizable layouts and attributes. The present technology addresses such challenges by providing an email backend system that allows users to define new mailboxes (layouts), add new variables (columns and column values), and dynamically apply filters and group email messages based on these user-defined variables. Such a system can allow a more personalized and flexible email management.

Specifically, the present technology introduces an extensible data model for email backend systems that provides users with customizable layouts, attributes, and columns. This data model allows users to create new mailboxes (represented as layouts), define and assign new columns to existing or new layouts, and apply filters and groupings based on these columns. Each column can have multiple attributes such as visibility, order, and sorting behavior, which can be customized per layout. This innovative approach enables an adaptable and efficient email management experience and addresses the limitations of conventional email systems.

In one example, an electronic device in communication with a backend server system receives, on a mailbox user interface associated with a user account, a first input to select an interface element indicating a particular layout among multiple layouts. The multiple layouts represent different ways of arranging email messages in the mailbox user interface. Each of the multiple layouts is associated with an identifier. Each of the multiple layouts defines a set of columns. Each column in of the set of columns defines values derivable from properties of email messages and each of the multiple layouts defines a grouping to be applied to email messages using one or more values defined in the set of columns. The multiple layouts are stored at the backend server system. Responsive to the first input, the device retrieves, based on an identifier associated with the particular layout, the particular layout from the backend server system. It provides, on the mailbox user interface, multiple email messages arranged in the particular layout. Providing the multiple email messages arranged in the particular layout includes providing a table including multiple rows and a particular set of columns defined by the particular layout. Providing the multiple email messages arranged in the particular layout also includes providing, for each of the rows corresponding to an email message, particular values for at least a portion of the columns. The particular values are defined by the particular set of columns and derived from the properties of each of the multiple email messages. The multiple email messages in the table are grouped according to one or more of the particular values.

In another example, a computer-implemented method includes receiving, by an electronic device on a mailbox user interface associated with a user account, a first input to select an interface element indicating a particular layout among multiple layouts. The multiple layouts represent different ways of arranging email messages in the mailbox user interface. Each of the multiple layouts is associated with an identifier. Each of the multiple layouts defines a set of columns, with each column of the set of columns defining values derivable from properties of email messages. The multiple layouts are stored at a backend server system in communication with the electronic device. Responsive to the first input, the method includes retrieving, based on an identifier associated with the particular layout, the particular layout from the backend server system. It provides, on the mailbox user interface, multiple email messages arranged in the particular layout. Providing the multiple email messages arranged in the particular layout includes providing a table with multiple rows and a particular set of columns defined by the particular layout. Providing the multiple email messages arranged in the particular layout also includes, for each of the rows corresponding to an email message, particular values for at least a portion of the columns. The particular values are defined by the particular set of columns and derived from the properties of each of the multiple email messages.

In yet another example, a backend server system receives, from an electronic device, a request for a particular layout among multiple layouts. The multiple layouts represent different ways of arranging email messages in a mailbox user interface on the electronic device. Each of the multiple layouts defines a set of columns, with each column of the set of columns defining values derivable from properties of email messages. The multiple layouts are stored at the backend server system. Responsive to the request, the system provides the particular layout to the electronic device. The system also causes the electronic device to provide, on the mailbox user interface, multiple email messages arranged in the particular layout. Providing the multiple email messages arranged in the particular layout includes providing a table with multiple rows and a particular set of columns defined by the particular layout. Providing the multiple email messages arranged in the particular layout also includes providing, for each of the rows corresponding to an email message, particular values for at least a portion of the columns. The particular values are defined by the particular set of columns and derived from the properties of each of the multiple email messages.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

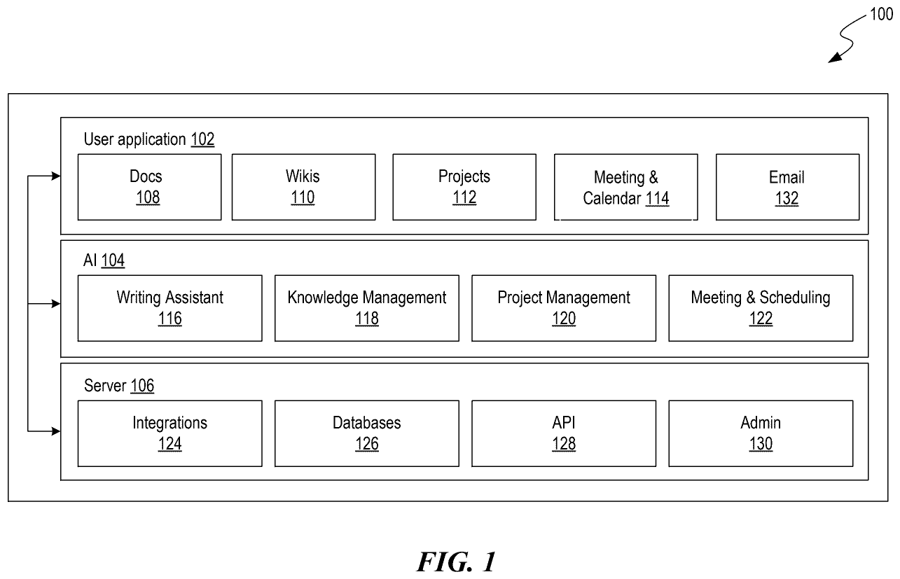

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

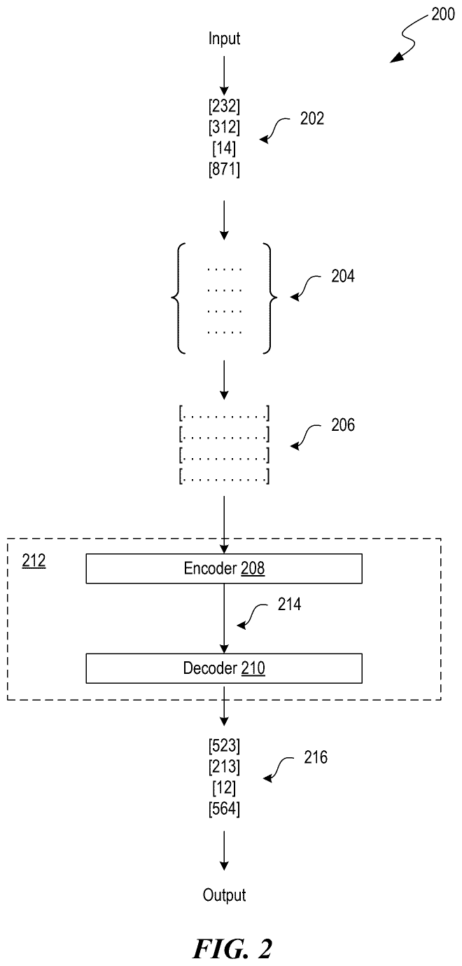

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco? ” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

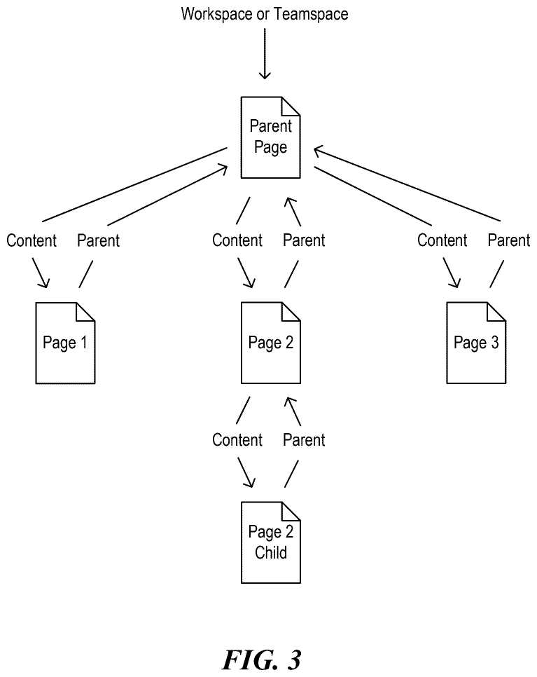

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Backend Email System

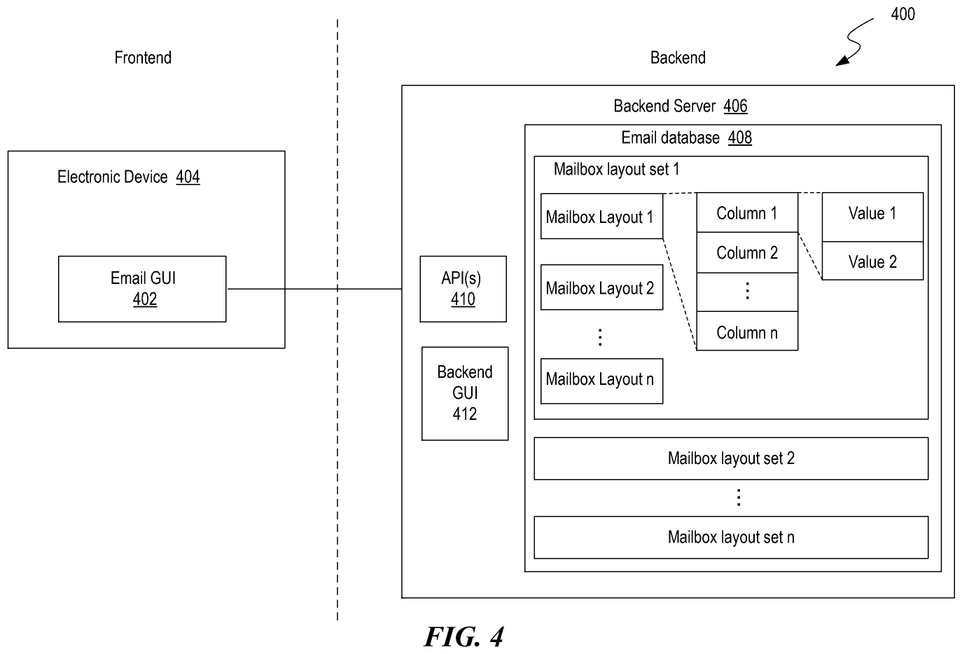

FIG. 4 is a block diagram illustrating an email system 400, in accordance with some embodiments. The email system 400 includes a backend server 406 and an electronic device 404 (e.g., a frontend device) in communication with each other. In some implementations, the backend server 406 corresponds to the server 106 described with respect to FIG. 1. The electronic device 404 is configured to provide an email graphical user interface (GUI) (e.g., an email GUI 402), for example, on a display of the electronic device 404. The email GUI 402 can be associated with an email user interface (e.g., as described with respect to the email template 132 in FIG. 1).

The backend server 406 includes one or more APIs 410 operating as intermediate between the backend server 406 and applications operating on the electronic device 404. The backend server 406 also includes an email database 408 (or an email data storage) that includes multiple mailbox layout sets (e.g., mailbox layout sets 1 through n). Each of the mailbox layout sets can include one or more mailbox layouts (e.g., the mailbox layout set 1 includes mailbox layouts 1 through n). Each of the mailbox layouts defines a set of columns (e.g., the mailbox layout 1 defines a set of columns including columns 1 through n). Each column further defines one or more column values (attributes) (e.g., column 1 of the mailbox layout 1 includes values 1 and 2). For example, a column value can store an actual attribute or information of an email message as it is defined by the column.

A mailbox layout can define a way of arranging email messages in the email GUI 402. For example, a mailbox layout can define the arrangement of email messages in a table (e.g., by a set of columns), grouping, filtering, or other criteria for providing email messages in the email GUI 402. The mailbox layout can generally define a table where each row corresponds to an email message, and each column can define one or more values which are derivable from properties of email messages. Examples of the values can include sender, receiver, subject, status (read or unread), date and time, or other properties of an email message. In some implementations, the values include AI (e.g., LLM) generated values that are generated based on content of one or more email messages (e.g., an AI-generated summary of email content, an AI-generated action item list, an AI-generated reply, an AI-generated profile of a sender, or a timeline associated with an email chain).

The mailbox layout sets 1 through n and layouts stored at the email database 408 can be associated with different user accounts (e.g., the mailbox layout sets and layouts can be user-specific and customizable). For example, the mailbox layout set 1 can be associated with a first user account associated with the email application and the mailbox layout set 2 can be associated with a second user account associated with the email application. The different mailbox layout sets can be defined by their perspective user accounts and thereby include different mailbox layouts and/or a different number of mailbox layouts. For example, user 1 associated with the user account 1 can define different mailbox layouts that they find useful for reviewing email messages with different contents. Exemplary layouts can include a layout specific for their work projects, a layout for viewing news, a layout for tracking spending (e.g., email receipts), a layout for personal matters, a layout for travel information, etc. The backend server further comprises or is in communication with a backend GUI 412 that can be used to create the mailbox layouts stored at the email database 408. The mailbox layouts can also be created using the one or more APIs 410.

The electronic device 404 can retrieve the different mailbox layouts from the email database 408 at the backend server to be displayed on the email GUI 402. For example, a user can switch between display of different mailbox layouts from a mailbox layout set that is associated with their user account by user inputs on the email GUI 402.

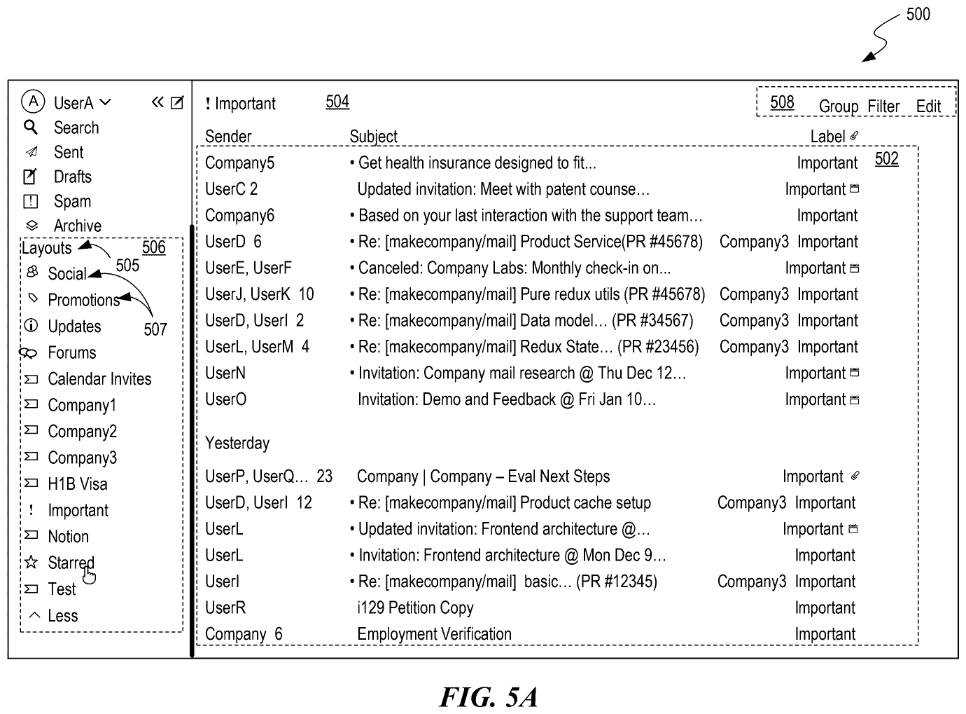

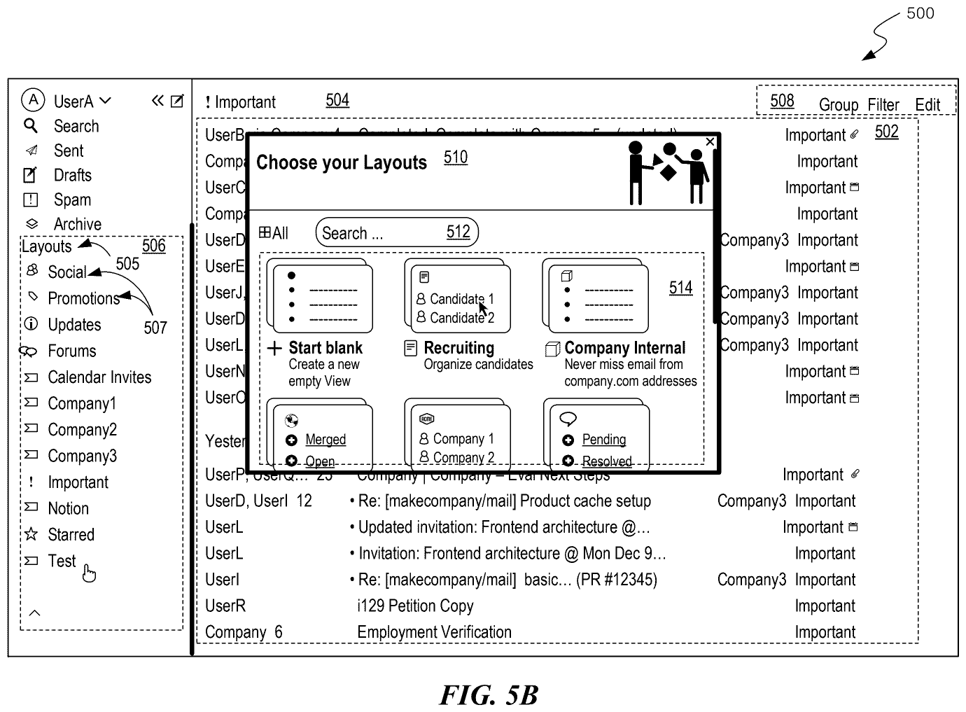

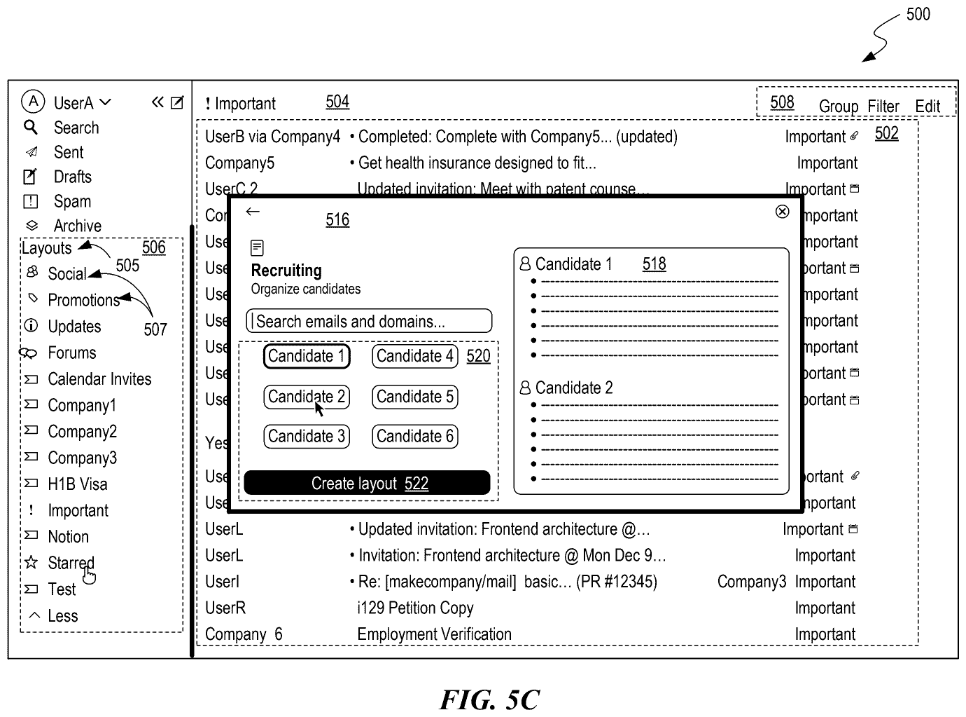

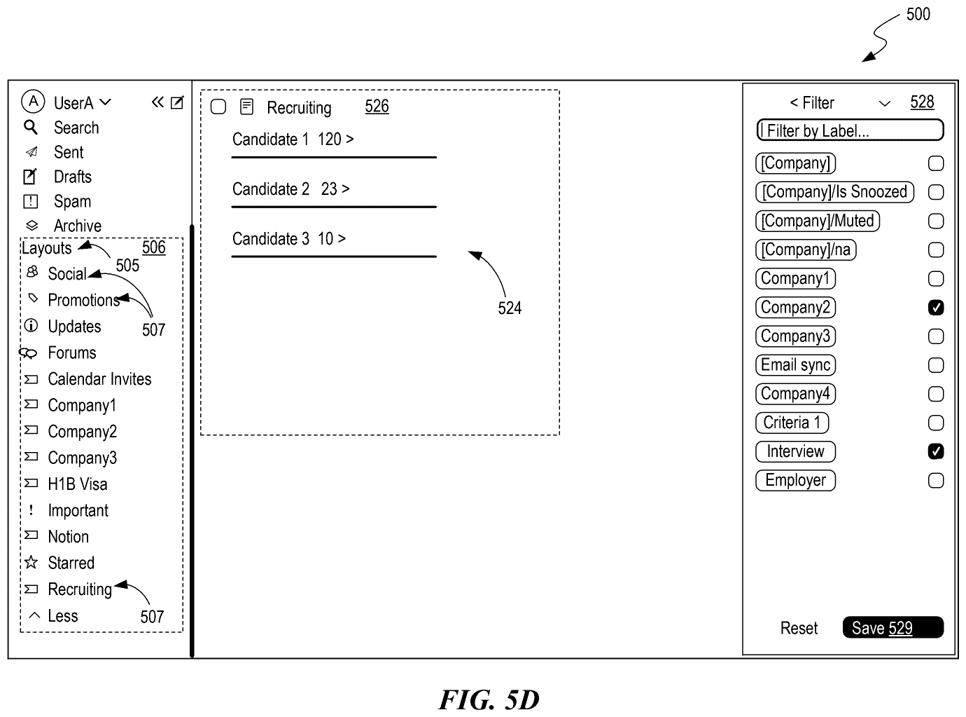

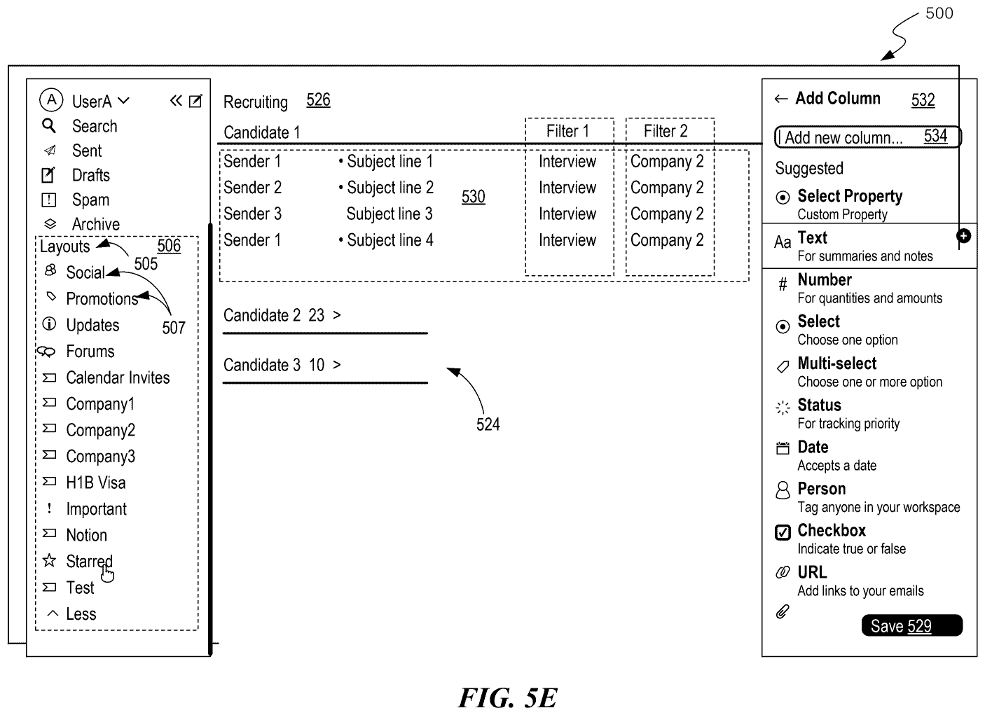

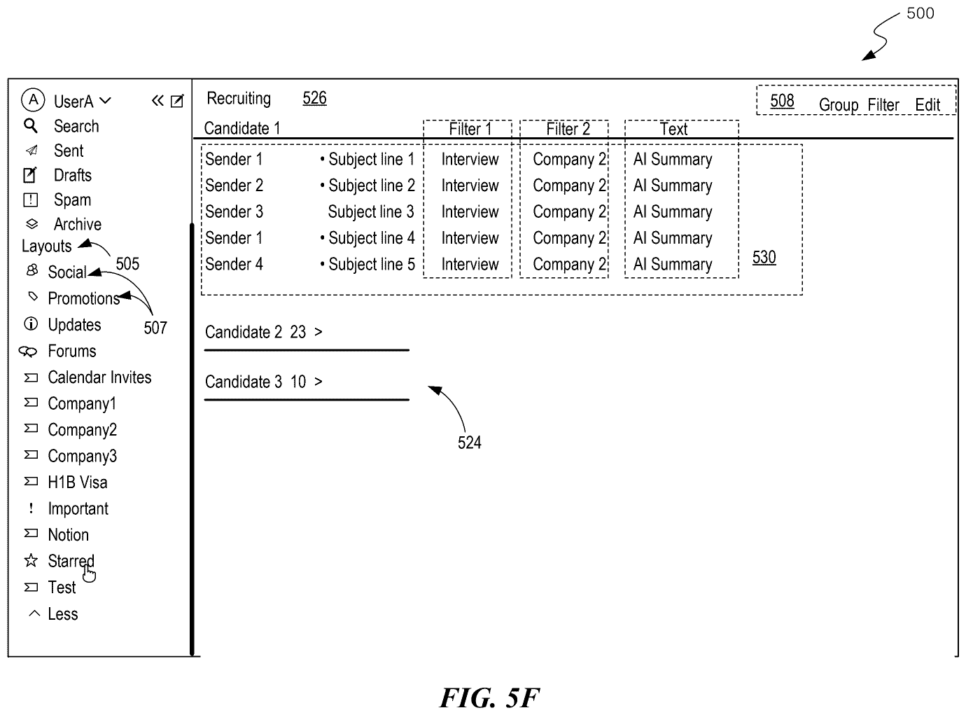

FIGS. 5A through 5F illustrate an email user interface, in accordance with some embodiments. The email user interface 500 can correspond to the email GUI 402 described with respect to FIG. 4. In FIG. 5A, the email user interface 500 includes email messages arranged in a table 502 accordance with a mailbox layout 504 titled “important.” The table 502 includes rows and columns. Each of the rows corresponds to an email message. Each of the columns corresponds to a property that can be derived from properties of the email messages (i.e., Sender column, Subject column and Label column). The mailbox layout 504 can, for example, be configured to include email messages that are categorized with a particular label (or a tag). The categorizing can be provided by a user or generated by an integrated AI system (e.g., the AI system determines based on the content of an email message whether the email messages should be categorized as important). The mailbox layout 504 defines the grouping and/or filtering of the email messages based on properties of the email (e.g., stored as column values for each of the columns). For example, the mailbox layout 504 can include a filter criterium that causes the email user interface 500 to only include email messages associated with a user account that are categorized as important. The table 502 in FIG. 5A can thereby include a portion (less than all) of the email messages that a mailbox (e.g., an inbox including received email messages) associated with the user account includes. The mailbox layout 504 can enable a user to efficiently review email messages that require urgent review or contain important information.

The email user interface 500 also includes a layout selection portion 506. The layout selection portion 506 includes multiple selectable interface elements. Interface elements 507 can allow a selection of a particular mailbox layout among multiple mailbox layouts. Each of the interface elements 507 in the layout selection portion 506 is associated with a unique mailbox layout. As described with respect to FIG. 4, such mailbox layouts can be stored at, and retrieved from, the email database 408 of the backend server 406. For example, the interface elements 507 in the layout selection portion 506 correspond to the mailbox layouts 1 through n of the mailbox layout set 1 in FIG. 4. These mailbox layouts 1 through n are specific to the user account associated with the email messages in the table 502.

A user can provide a user input (e.g., a click) on any of the user interfaces (e.g., the user interface element 507 titled “Social”). In response to the input, the electronic device 404 in FIG. 4 can retrieve the associated mailbox layout from the email database 408 of the backend server 406 and provide email messages in the email user interface 500 arranged according to the retrieved layout. An interface element 505 (“Layouts”) can allow a user to open a layout selection user interface (e.g., a layout creation user interface 510 described in FIG. 5B) that enables a user to create a new layout from among multiple layout templates or to generate a new layout without a template (from scratch).

The email user interface 500 can further include interface elements for modifying the mailbox layout 504 (e.g., interface elements 508). The interface elements can include an interface element for adding a grouping criterium (“Group”), adding a filter criterium (“Filter”), and/or other editing criterium (“Edit”). Modifications to a mailbox layout 504 using the interface elements 508 are described with respect to FIGS. 5D through 5F.

FIG. 5B illustrates the layout creation user interface 510 (e.g., as a pop-up window) which is provided on the email user interface 500 in response to a user input on the interface element 505. The layout creation user interface 510 includes multiple interface elements 514 that are representative of customizable templates for creating mailbox layouts. The templates can be used to define mailbox layouts defining a variety of different column sets and column values. The templates shown in FIG. 5B include, for example, a template for recruiting, a template for company internal email, and a blank template for creating a new customized template. The layout creation user interface 510 can also include a search bar 512 for searching templates using input keywords.

FIG. 5C illustrates a layout template user interface 516 (e.g., a template for recruiting). The layout template user interface 516 can be opened in response to a user selecting one of the multiple interface elements 514 that are representative of customizable templates for creating mailbox layouts in the layout creation user interface 510 in FIG. 5B. The layout template user interface 516 enables a user to select properties and features for a layout to be created. For example, the layout template user interface 516 associated with recruiting includes interface elements 520 for selecting one or more candidate names to be included in the created view. The candidate names can correspond to values that are extracted from multiple email messages associated with the user account. Further, the layout template user interface 516 can include a section 518 for AI-generated content that is created based on selected candidates associated with the interface elements 520 (e.g., candidates 1 and 2) and email messages associated with these selected candidates. The AI-generated content can include summaries, action item lists, automated responses to email messages, or any other AI-generated data generated based on the email messages. For example, in an instance of a template for recruiting (e.g., the layout template user interface 516), the section 518 can include an AI-generated summary of interview results. The template for recruiting can include a column defining a prompt (e.g., a set of instructions) that generates a summary based on the content of the email messages associated with a selected candidate. The prompt, along with the email messages or a portion of the email messages, can be transmitted to an AI system. The AI system can identify, based on the prompt, those email message content that discusses interview results (e.g., email messages from interviewers who interviewed the selected candidate) and generate a summary of the interview results.

After selection of desired properties in the layout template user interface 516, a user can provide an input on the interface element 522 to create a new layout based on the template and the selected properties. In response to the input on the interface element 522, the new layout called “Recruiting” can be stored at the database 408 of the backend server 406 in FIG. 4. The storing can be mediated by the one or more APIs 410 of the backend server 406. Further, an interface element 507 called “Recruiting” associated with the new layout can be added to the layout selection portion 506, as shown in FIG. 5D. Alternatively, mailbox layouts can be created and existing mailbox layouts can be modified by the backend GUI 412 described with respect to FIG. 4. In some implementations, the backend GUI 412 can be accessed by the electronic device 404 or another electronic device in communication with the backend server 406.

FIG. 5D illustrates the email user interface 500 including a recruiting mailbox layout 526. The recruiting mailbox layout 526 includes email messages defined by the recruiting layout created, as described with respect to FIG. 5C. For example, the recruiting mailbox layout 526 includes email groups 524 grouped and filtered according to selected candidates (e.g., candidates 1, 2, 3). In FIG. 5D, tables including email messages associated with these candidates are hidden and can be displayed in response to a click on a respective candidate name. Each of the groups includes an identifier (e.g., a candidate's name) and a number of email messages included in each of the groups. For example, the candidate 1 is associated with 120 email messages.

In FIG. 5D, the email user interface further includes a filtering section 528 that enables a user to select further filter criteria for displaying email messages in the recruiting mailbox layout 526. The filtering section can be displayed, for example, in response to a user input on the “Filter” interface element 508 described with respect to FIG. 5A. The email messages can be filtered (e.g., limited) based on a variety of properties (corresponding to values or attributes) directly or indirectly derived from properties of the email messages. The properties can include tags or labels (either selectable by a user or generated by the AI system), date/time criteria, sender criteria, receiver criteria, keywords, etc. For example, in FIG. 5D a user has selected the properties corresponding to “Company 2” and “Interview” as additional filtering criteria. For example, such selection can correspond to filtering out all email messages associated with candidates 1, 2, and 3 that do not include information regarding interviews for company 2, as is shown in FIG. 5E. A user can save the selected filter criteria, e.g., by providing an input on a save interface element 529. In response to the input to save the selected filter criteria, the backend server 406 can store the modified recruiting mailbox layout 526, including the added filtering criteria, to the email database 408. Similarly any other edits and modifications to the recruiting mailbox layout can be stored by the backend server 406 to the email database 408. The modifications described with respect to FIGS. 5D (and 5E and 5F) can be implemented to the email user interface 500 in real-time such that a user can immediately after making a modification to the displayed layout view the email messages in accordance with the modified layout. Further, the modifications can be stored by the backend server 406 to the email database 408 in real-time or nearly real-time.

In FIG. 5E, the recruiting mailbox layout 526 includes a table 530 including email messages for candidate 1 (e.g., displayed in response to a user providing an input on the “candidate 1” of groups 524 in FIG. 5D). As shown, after applying the selected filtering criteria from FIG. 5D (i.e., filter 1 corresponding to “Company 2” and filter 2 corresponding to “Interview”), the table 530 includes a portion (e.g., five) of the email messages associated with candidate 1 that also include the generated tags or labels, or keywords extracted from the email messages corresponding to filter 1 and filter 2. In comparison, in FIG. 5D, candidate 1 was indicated to be associated with 120 email messages. Further, the table 530 includes columns associated with filter 1 and 2.

FIG. 5E further includes a column addition section 532 that enables a user to add one or more columns associated with one or more properties of email messages to the recruiting mailbox layout 526. For example, the column addition section 532 can include a list of suggested properties that could be added as columns. As shown in FIG. 5E, a user has selected to add a text column. A user can further be prompted to define, either by selecting or typing, values or attributes associated with the text column to be added. Further, a user can also provide an input on an input interface element 534 to define a new name and/or values for a new column. As explained above, the values can include properties derived from email messages (e.g., the content of email messages). The values can be generated by an AI system or include prompts that provide instructions to the AI system to create values. For example, the AI system can generate summaries, action item lists, automated responses to email messages, or any other AI-generated data. The AI system can also categorize or provide suggestions related to email messages. The values can also be either predefined (e.g., date, sender, receiver) or defined by a user. The “Multi-select” interface element in the list can allow a user to add multiple columns at once or associate multiple values with a column. In response to a user's input to define a text column including AI-generated summary, the table 530 includes a new column titled “Text.” The text column defines a value corresponding to an AI-generated summary for each of the email messages in the table 530.

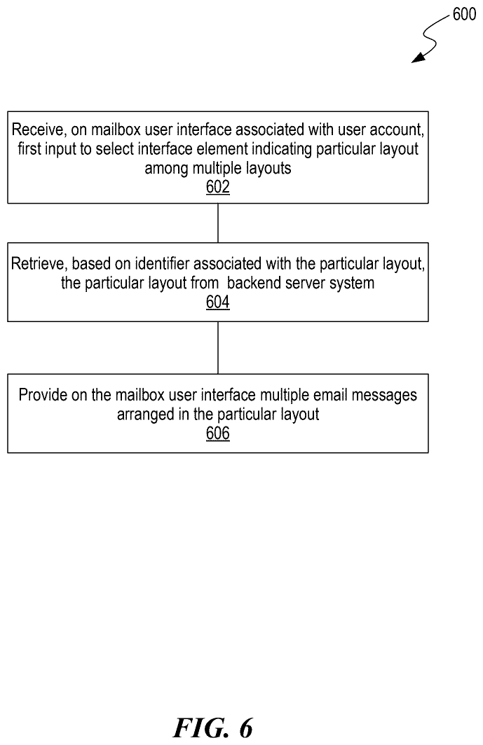

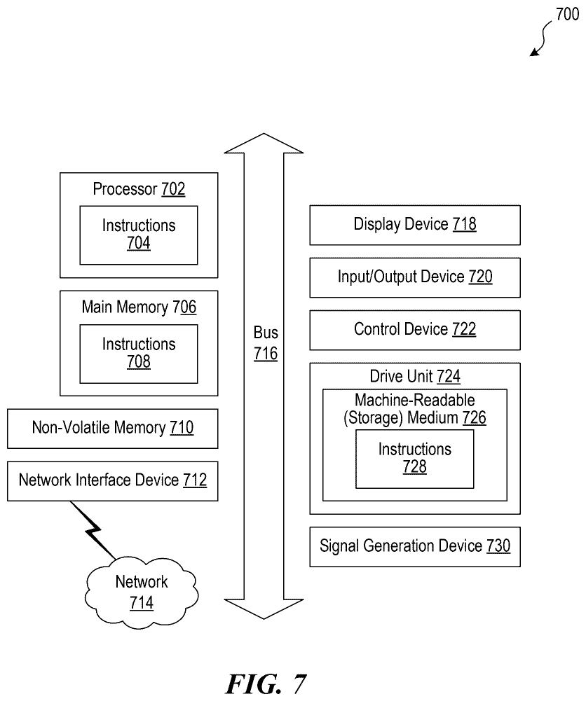

FIG. 6 is a flow diagram illustrating a process 600 for providing customizable mailbox layouts in an email system, in accordance with some embodiments. The process 600 can be performed by an electronic device of an email system (e.g., the electronic device 404 in communication with the backend server 406 of the email system 400 described with respect to FIG. 4). The customizable mailbox layouts can include features described with respect to FIGS. 5A through 5F. The system can be a computer system (e.g., the computer system 700 described with respect to FIG. 7).

The process 600 is directed to an extensible data model for email backend systems, offering customizable layouts, attributes, and columns. Users can create new mailbox views (layouts), define and assign columns, and apply filters and groupings. Each column's attributes, like visibility, order, and sorting, can be customized per layout. The disclosed technology can enhance email management efficiency and prevent negative user experiences associated with cluttered mailboxes.

At 602, the device receives, on a mailbox user interface (e.g., the email user interface 500 described with respect to FIGS. 5A through 5F) associated with a user account, a first input to select an interface element indicating a particular layout among multiple layouts (e.g., an input to select any of the interface elements 507 in the layout selection portion 506 in FIG. 5A). The multiple layouts can represent different ways of arranging email messages in the mailbox user interface. Each of the multiple layouts can be associated with an identifier. The identifier can be a name (e.g., the names “Social” and “Promotions” included in the interface elements 507 in FIG. 5A). The identifier can also include a code or number associated with each of the multiple layouts that is stored in association with each of the layouts. Each of the multiple layouts can define a set of columns. For example, the recruiting mailbox layout 526 in FIG. 5F includes columns for a sender, a subject line, filter 1, filter 2, and text. Each column of the set of columns can define values derivable from properties of email messages and each of the multiple layouts defines a grouping to be applied to email messages using one or more values defined in the set of columns. The grouping can be defined, for example, based on the content of email messages (e.g., a subject line, a sender, a receiver, an email body, an organization associated with a sender or receiver, a date or time, a label (e.g., importance, unread vs. read, promotion, advertisement, or news). For example, in FIG. 5F, the recruiting mailbox layout 526 titled “recruiting” includes a grouping based on a value of candidate (e.g., candidates 1, 2, and 3). The grouping titled “Candidate 1” can include email messages that relate to the recruiting of candidate 1. For example, the name of candidate 1 is included somewhere in the content of the email messages. As another example, in FIG. 5A, the mailbox layout 504 includes email messages grouped by time (e.g., email messages received the previous day are grouped under the title “yesterday” while received today are provided at the beginning of the table 502).

The multiple mailbox layouts can be stored at the backend server system. As described with respect to FIG. 4, the backend server 406 includes the email database 408 storing multiple mailbox layouts (e.g., the mailbox layouts 1 through n). The backend server 406 is in communication with the electronic device 404, e.g., via the one or more APIs 410.

At 604, responsive to the first input, the device retrieves the particular layout from the backend server system based on an identifier associated with the particular layout. For example, the electronic device 404 in FIG. 4 transmits a request to the backend server 406 to retrieve the particular layout. The request can include an identifier that is unique to the particular layout.

At 606, the device provides on the mailbox user interface multiple email messages arranged in the particular layout (e.g., as illustrated by the mailbox layout 504 in FIG. 5A and the recruiting mailbox layout 526 in FIG. 5F). Providing the multiple email messages arranged in the particular layout includes providing a table including multiple rows (e.g., the table 502 in FIG. 5A includes multiple rows corresponding to email messages) and a particular set of columns (e.g., the table 502 includes columns for a sender, a subject, and a label) defined by the particular layout (e.g., mailbox layout 504 is arranged in accordance with a layout titles “Important.” Providing the multiple email messages arranged in the particular layout also includes providing, for each of the rows corresponding to an email message, particular values for at least a portion of the columns. For example, in the table 502 in FIG. 5A, the sender column defines a value corresponding to sender information associated with the email messages, the subject column defines a value corresponding to subject line information associated with the email messages, and the label column defines a value corresponding to one or more labels associated with the email messages. The particular values are defined by the particular set of columns and derived from the properties of each of the multiple email messages. For example, in FIG. 5A, the values for the sender, subject, and label are derived from the properties (e.g., the content or metadata) of the email messages. The multiple email messages in the table are grouped according to one or more of the particular values. The table 502 in FIG. 5A includes email messages that are grouped based on the label. For example, the table 502 includes email messages that are associated with a label “Important.” Further, the email messages are grouped based on date and time or receiving the email (e.g., the newest email messages are grouped in the top portion of the table while email messages from the day before are grouped under “Yesterday.”).

In some implementations, the electronic device is further caused to receive, on the mailbox user interface, a second input to select a filter criterium to be applied to the multiple email messages in the particular layout (e.g., as described with respect to FIGS. 5D and 5E). The filter criterium defines a particular label assigned to a subset of the multiple email messages based on the content of the multiple email messages. Responsive to the second input, the device provides a modified table in the particular layout comprising the subset of the multiple email messages and causes the backend server system to update the stored particular layout to include the selected filter criterium. The electronic device can send the backend server system an indication that a user has modified the particular layout, and the backend server system stores the updated particular layout to its database.

In some implementations, the electronic device is further caused to receive, on the mailbox user interface, a third input to add an additional column to the particular set of columns (e.g., as described with respect to FIGS. 5E and 5F). The additional column defines one or more values derivable from the properties of the multiple email messages. Responsive to the third input, the device provides a modified table in the particular layout comprising the additional column with the one or more values derived from the properties of the multiple email messages and causes the backend server system to update the stored particular layout to include the additional column.

In some implementations, the multiple layouts and the email messages are associated with the user account. For example, the selection of different layouts represented by the interface elements 507 in the layout selection portion 506 can be user account specific in that a user can add to the selection such mailbox layouts that they wish to use and customize them based on their needs and desires. A layout can be created based on a predefined template (e.g., as described with respect to FIGS. 5C and 5D) or be generated by a user (e.g., using the “start blank” interface element function in the layout creation user interface 510 in FIG. 5B). Each column of the particular set of columns includes a user identifier indicating the user account.

In some implementations, the electronic device is further caused to receive, on the mailbox user interface, a fourth input to select an interface element indicating an additional layout, different from the particular layout, among multiple layouts. The additional layout defines an additional set of columns different from the particular set of columns. Responsive to the fourth input, the device retrieves, based on an identifier associated with the additional layout, the additional layout from the backend server system and provides, on the mailbox user interface, at least a portion of the multiple email messages arranged in the additional layout. As described with respect to FIGS. 5A through 5F, a user can open different layouts using the interface elements 507 in the layout selection portion 506, create new layouts via the layout creation user interface 510 (FIG. 5B), and modify the layouts by adding one or more filter and/or one or more columns (FIGS. 5D through 5F). Different layouts can define different sets of columns and different criteria for filters and grouping.

In some implementations, the multiple layouts are created based on user inputs received on a backend user interface (e.g., the backend GUI 412 in FIG. 4) configured for creating and generating customized user interfaces. The backend user interface can be accessible to a user via the electronic device (e.g., the electronic device 404) or a different electronic device that is in communication with the backend server 406.

In some implementations, the user account is associated with a first set of email messages including all messages received by, and sent from, the user account. The particular layout includes a filter criterium defining a particular label assigned to at least a portion of the first set of email messages. The multiple email messages are a subset of the first set of email messages including the particular label. For example, in FIG. 5A the table 502 includes email messages that are associated with the label “important.” The email messages in the table 502 can correspond to a portion of all email messages in an inbox of a user's mailbox because less than all of the email messages are likely labeled as important.

In some implementations, the values derivable from the properties of email messages include values derived using AI. For example, as described with respect to FIG. 5F, the table 530 includes a column for text information that is associated with an AI-generated summary. The AI-generated summary includes a summary generated by an AI system based on content of the each of the email messages. A user can define (e.g., by a customized prompt) an AI-generated content value for a column. Other non-limiting examples of AI-generated text include an AI-generated summary of email content, an AI-generated action item list, an AI-generated reply, an AI-generated profile of a sender, or a timeline associated with an email chain. In some implementations, the particular set of columns includes a column defining a value generated by an AI system in communication with the electronic device.

Layouts can be associated with one or more layout attributes, such as: layoutID: a unique identifier for the layout; name: the name of the layout, allowing users to differentiate between various mailboxes; groupByColumnID: an optional field indicating the column by which emails will be grouped within the layout; layoutFilters: a set of filters applied to this layout, which allows emails to be dynamically displayed based on certain criteria. Columns can be associated with one or more colum attributes, such as: columnID: a unique identifier for each column; type: specifying the data type of the column (e.g., text, number, date, Boolean); ApplicationType: defining specific behaviors for columns, such as whether it is a status field or a multi-select; userID: an identifier of the user associated with this column, allowing columns to be user-specific. Columns can be dynamic and can be added to layouts on demand (e.g., FIGS. 5E and 5F). Columns can be created with various data types and attributes, such as visibility, sorting order, and filtering options. As described with respect to FIG. 4, columns can be stored in the database and are linked to both layouts and users. Column values can be associated one or more value attributes, such as: LayoutFilterOperator: defining operators for filtering (e.g., EQUALS, CONTAINS, BETWEEN_DATES); and groupByColumnID: specifying which column is used to group emails in a layout. Filters and grouping can be applied dynamically to layouts, allowing users to adjust their views in real-time (e.g., FIGS. 5D through 5F). Filters can be processed on the backend server system using database indexes and query optimization techniques.

An exemplary implementation of the present technolgy involves using a combination of the following technologies: Relational Database: PostgreSQL with JSONB support for storing dynamic data and enabling efficient indexing for queries based on column values; ORM (Object-Relational Mapping): Prisma ORM to manage schema and migrations dynamically, ensuring smooth integration with TypeScript/Node.js backends; Backend Framework: A modern Node.js/TypeScript backend framework such as NestJS or Express.js for building RESTful APIs that allow users to manage layouts, columns, and filters; Frontend Integration: Email clients can interact with the backend system via API endpoints to fetch the layouts, apply filters, and group emails dynamically based on user preferences. User interactions trigger API calls that adjust layouts in real-time.

Exemplary use cases can include recruiting layout (e.g., a recruiter can create a layout that groups conversations by candidate, with columns representing the candidate's application status, interview date, and feedback score. This allows the recruiter to efficiently manage hiring pipelines); a sales layout (e.g., a sales manager can group emails by domain (representing companies) and add columns like lead score, industry type, and last contact date to assist in tracking email conversations with potential clients); a development layout (e.g., a software developer can organize email notifications by status (open, merged, or closed) and sort by repository name or issue number, improving the ability to manage code review workflows).

Exemplary features of the an implementation can include indexing for performance and sharding for scalability. The system can employ advanced indexing strategies, including GIN (Generalized Inverted Indexes) for fast retrieval of array or JSONB-based data. The JSONB data type stores JSON (JavaScript Object Notation) data as a binary representation of the JSONB value, which eliminates whitespace, duplicate keys, and key ordering. The system can employ UUID-based sharding allowing the system to scale across multiple database instances or nodes, supporting millions of users with minimal latency.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computer system 700 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 700. In some implementations, the computer system 700 can be an embedded computer system, a system-on-chip (SOC), a single-board computer (SBC) system, or a distributed system such as a mesh of computer systems or include one or more cloud components in one or more networks. Where appropriate, one or more computer systems 700 can perform operations in real time, near real time, or in batch mode.

The network interface device 712 enables the computer system 700 to mediate data in a network 714 with an entity that is external to the computer system 700 through any communication protocol supported by the computer system 700 and the external entity. Examples of the network interface device 712 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computer system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computer system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. An electronic device in communication with a backend server system, the electronic device comprising:
at least one hardware processor; and
at least one non-transitory memory storing instructions, which, when executed by the at least one hardware processor, cause the electronic device to:
receive, on a mailbox user interface associated with a user account, a first input to select an interface element indicating a particular layout among multiple layouts,
wherein the multiple layouts represent different ways of arranging email messages in the mailbox user interface,
wherein each of the multiple layouts is associated with an identifier,
wherein each of the multiple layouts defines a set of columns, each column of the set of columns defining values derivable from properties of email messages,
wherein each of the multiple layouts defines a grouping to be applied to email messages using one or more values defined in the set of columns, and
wherein the multiple layouts are stored at the backend server system;
responsive to the first input, retrieve, based on an identifier associated with the particular layout, the particular layout from the backend server system; and
provide, on the mailbox user interface, multiple email messages arranged in the particular layout, the providing comprising:
providing a table including multiple rows and a particular set of columns defined by the particular layout, and
providing, for each of the rows corresponding to an email message, particular values for at least a portion of the columns, the particular values defined by the particular set of columns and derived from the properties of each of the multiple email messages,
wherein the multiple email messages in the table are grouped according to one or more of the particular values.

2. The electronic device of claim 1, wherein the electronic device is further caused to:
receive, on the mailbox user interface, a second input to select a filter criterium to be applied to the multiple email messages in the particular layout,
wherein the filter criterium defines a particular label assigned to a subset of the multiple email messages based on content of the multiple email messages;
responsive to the second input, provide a modified table in the particular layout comprising the subset of the multiple email messages; and
cause the backend server system to update the stored particular layout to include the selected filter criterium.

3. The electronic device of claim 1, wherein the electronic device is further caused to:
receive, on the mailbox user interface, a third input to add an additional column to the particular set of columns,
wherein the additional column defines one or more values derivable from properties of the multiple email messages;
responsive to the third input, provide a modified table in the particular layout comprising the additional column with the one or more values derived from the properties of the multiple email messages; and
cause the backend server system to update the stored particular layout to include the additional column.

4. The electronic device of claim 1,
wherein the multiple layouts and the email messages are associated with the user account, and
wherein each of the particular set of columns includes a user identifier indicating the user account.

5. The electronic device of claim 1, wherein the electronic device is further caused to:
receive, on the mailbox user interface, a fourth input to select an interface element indicating an additional layout, different from the particular layout, among multiple layouts,
wherein the additional layout defines an additional set of columns different from the particular set of columns;
responsive to the fourth input, retrieve, based on an identifier associated with the additional layout, the additional layout from the backend server system; and
provide, on the mailbox user interface, at least a portion of the multiple email messages arranged in the additional layout.

6. The electronic device of claim 1,
wherein the multiple layouts are created based on user inputs received on a backend user interface configured for creating and generating customized user interfaces.

7. The electronic device of claim 1,
wherein the user account is associated with a first set of email messages including all messages received by, and send from, the user account,
wherein the particular layout includes a filter criterium defining a particular label assigned to at least a portion of the first set of email messages, and
wherein the multiple email messages are a subset of the first set of email messages including the particular label.

8. The electronic device of claim 1,
wherein the values derivable from the properties of email messages include values derived using artificial intelligence (AI).

9. The electronic device of claim 1,
wherein the particular set of columns includes a column defining a value generated by an artificial intelligence (AI) system in communication with the electronic device.

10. A computer-implemented method comprising:
receiving, by an electronic device on a mailbox user interface associated with a user account, a first input to select an interface element indicating a particular layout among multiple layouts,
wherein the multiple layouts represent different ways of arranging email messages in the mailbox user interface,
wherein each of the multiple layouts is associated with an identifier,
wherein each of the multiple layouts defines a set of columns, each column of the set of columns defining values derivable from properties of email messages, and
wherein the multiple layouts are stored at a backend server system in communication with the electronic device;
responsive to the first input, retrieving, based on an identifier associated with the particular layout, the particular layout from the backend server system; and
providing, on the mailbox user interface, multiple email messages arranged in the particular layout, the providing comprising:
providing a table including multiple rows and a particular set of columns defined by the particular layout, and
providing, for each of the rows corresponding to an email message, particular values for at least a portion of the columns, the particular values defined by the particular set of columns and derived from the properties of each of the multiple email messages.

11. The computer-implemented method of claim 10, further comprising:
receiving, on the mailbox user interface, a second input to select a filter criterium to be applied to the multiple email messages in the particular layout,
wherein the filter criterium defines a particular label assigned to a subset of the multiple email messages based on content of the multiple email messages;
responsive to the second input, providing a modified table in the particular layout comprising the subset of the multiple email messages; and
causing the backend server system to update the stored particular layout to include the selected filter criterium.

12. The computer-implemented method of claim 10, wherein the electronic device is further caused to:
receive, on the mailbox user interface, a third input to add an additional column to the particular set of columns,
wherein the additional column defines one or more values derivable from properties of the multiple email messages;
responsive to the third input, provide a modified table in the particular layout comprising the additional column with the one or more values derived from the properties of the multiple email messages; and
cause the backend server system to update the stored particular layout to include the additional column.

13. The computer-implemented method of claim 10,
wherein the multiple layouts and the email messages are associated with the user account, and
wherein each of the particular set of columns includes a user identifier indicating the user account.

14. The computer-implemented method of claim 10, further comprising:
receiving, on the mailbox user interface, a fourth input to select an interface element indicating an additional layout, different from the particular layout, among multiple layouts,
wherein the additional layout defines an additional set of columns different from the particular set of columns;
responsive to the fourth input, retrieving, based on an identifier associated with the additional layout, the additional layout from the backend server system; and
providing, on the mailbox user interface, at least a portion of the multiple email messages arranged in the additional layout.

15. The computer-implemented method of claim 10,
wherein the multiple layouts are created based on user inputs received on a backend user interface configured for creating and generating customized user interfaces.

16. The computer-implemented method of claim 10, further comprising:
receiving, on the mailbox user interface, a fourth input to select an interface element indicating an additional layout, different from the particular layout, among multiple layouts,
wherein the additional layout defines an additional set of columns different from the particular set of columns;
responsive to the fourth input, retrieving, based on an identifier associated with the additional layout, the additional layout from the backend server system; and
providing, on the mailbox user interface, at least a portion of the multiple email messages arranged in the additional layout.

17. The computer-implemented method of claim 10,
wherein the multiple layouts are created based on user inputs received on a backend user interface configured for creating and generating customized user interfaces.

18. At least one non-transitory, computer-readable storage medium comprising instructions recorded thereon, wherein the instructions, when executed by at least one data processor of a backend server system, cause the system to:
receive, from an electronic device, a request for a particular layout among multiple layouts,
wherein the multiple layouts represent different ways of arranging email messages in a mailbox user interface on the electronic device,
wherein each of the multiple layouts defines a set of columns, each column of the set of columns defining values derivable from properties of email messages, and
wherein the multiple layouts are stored at the backend server system;
responsive to the request, provide the particular layout to the electronic device; and cause the electronic device to provide, on the mailbox user interface, multiple email messages arranged in the particular layout, the providing comprising:
providing a table including multiple rows and a particular set of columns defined by the particular layout, and
providing, for each of the rows corresponding to an email message, particular values for at least a portion of the columns, the particular values defined by the particular set of columns and derived from the properties of each of the multiple email messages.

19. The at least one non-transitory, computer-readable storage medium of claim 18, wherein the system is further caused to:
receive, from the electronic device, a request to update the particular layout to include a filter criterium to be applied to the multiple email messages in the particular layout,
wherein the filter criterium defines a particular label assigned to a subset of
the multiple email messages based on content of the multiple email messages; and
update the stored particular layout to include the filter criterium.

20. The at least one non-transitory, computer-readable storage medium of claim 18, wherein the system is further caused to:
receive, from the electronic device, a request to update the particular layout to include an additional column to the particular set of columns of the particular layout,
wherein the additional column defines one or more values derivable from properties of the multiple email messages; and
update the stored particular layout to include the additional column.
